(19) United States
(12) Patent Application Publication
(10) Pub. No.: US 2016/0041051 A1
(43) Pub. Date: Feb. 11, 2016

(54) METHOD AND APPARATUS FOR DETERMINING AND DISPLAYING FORCE APPLIED BY CYCLIST

(71) Applicant: Garmin Switzerland GmbH, Schaffhausen (CH)

(72) Inventors: Theodorus J. Smit, Calgary (CA); Clark F. Foy, Los Gatos, CA (US); Alan D. Weatherall, San Jose, CA (US); Geoffrey A. Thomas, Cochrane (CA); Kenneth A. Carlson, Gardner, KS (US)

(21) Appl. No.: 14/726,096

(22) Filed: May 29, 2015

Related U.S. Application Data
(60) Provisional application No. 62/035,724, filed on Aug. 11, 2014.

(51) Int. Cl. G01L 5/22; A63B 22/06; A63B 24/00

(52) U.S. Cl. CPC G01L 5/225; A63B 24/0062; A63B 22/0605

(57) ABSTRACT

A method and apparatus for determining a power phase and other force-related performance of a bicyclist while riding a bicycle. Sensors measure a force applied by the bicyclist to the left and right pedals. The measurement data is analyzed to determine the power phase performance by correlating the force applied by the bicyclist to the left and right pedals with corresponding angles of the left and right cranks. A series of changes in the power phase performance during the ride is recorded. A series of changes in the geographic location of the bicyclist and/or a series of changes in one or more performance metrics while riding the bicycle may also be recorded. The series of changes in the bicyclist's power phase performance, the geographic location, and the performance metrics may be correlated, graphically communicated in real-time or post-ride, and used to improve the bicyclist's performance.

### RELATED APPLICATIONS

The current U.S. non-provisional patent application claims priority benefit, with regard to all common subject matter, of an earlier-filed U.S. provisional patent application titled “METHOD AND APPARATUS FOR DETERMINING AND DISPLAYING FORCE APPLIED BY CYCLIST”, Application Ser. No. 62/035,724, filed Aug. 11, 2014. The earlier-filed application is hereby incorporated by reference into the current application in its entirety.

### BACKGROUND

Bicycles may be configured to measure a bicyclist's level of effort. For example, a bicycle may include a pedal with a pedal spindle provided with one or more sensors configured to measure the forces exerted by the bicyclist on the pedal. More specifically, Garmin's Vector™ pedals incorporate a plurality of sensors that measures the forces applied by a bicyclist to a bicycle's pedals based on an amount of deformation of the bicycle's pedal spindles. This technology is described in U.S. Pat. No. 8,011,242, which is hereby incorporated by reference into the current application in its entirety. The sensors are coupled with a memory element configured to store executable instructions, and a processing element configured to execute those instructions in order to analyze the measured forces and provide information related to the pedaling of the bicyclist. The sensors and/or processing element may be coupled with a display configured to communicate the information to the bicyclist. The information may include a visual indication of the determined forces, where forces are being wasted, and where energy may be saved without affecting driving force and speed. Thus, one use for the information is to improve the pedaling efficiency of the bicyclist by reducing wasted force exerted on the pedal.

### SUMMARY

Embodiments of the technology concern a method and apparatus for determining and displaying a force applied by a bicyclist while riding a bicycle. One or more sensors measure a force applied by the bicyclist to the left and right pedals. The measurement data is analyzed to determine the power phase performance by correlating the force applied by the bicyclist to the left and right pedals with corresponding angles of the left and right cranks. A series of changes in the power phase performance during the ride is recorded. A series of changes in the geographic location of the bicyclist and/or a series of changes in one or more performance metrics while riding the bicycle may also be recorded. The series of changes in the bicyclist's power phase performance, the geographic location, and the performance metrics may be correlated, graphically communicated in real-time or post-ride, and used to improve the bicyclist's performance.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology are described in detail below with reference to the attached drawing figures, wherein:

FIG. 1 is a side elevation view of an embodiment of an electronic device configured to determine a bicyclist's bodily position while the bicyclist is riding a bicycle, wherein the electronic device is shown mounted on the bicycle;

FIG. 2 is a plan view of the electronic device of FIG. 1;

FIG. 3 is a schematic depiction of constituent elements of the electronic device of FIG. 1;

FIG. 4 is a fragmentary side elevation view of the bicyclist's foot exerting force on a pedal component of the bicycle of FIG. 1;

FIG. 5 is a depiction of a real-time display of the bicyclist's performance while riding the bicycle;

FIG. 6 is a depiction of a change over time in the bicyclist's performance while riding the bicycle; and

FIG. 7 is a flowchart of steps involved in a method implemented by the electronic device of FIG. 1.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology may be practiced. The embodiments are intended to describe aspects of the technology in sufficient detail to enable those skilled in the art to practice the technology. Other embodiments may be utilized and changes may be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology may include a variety of combinations and/or integrations of the embodiments described herein.

Embodiments of the technology apply to the field of bicyclist performance analysis, and more specifically, to determining forces applied by a bicyclist to left and right bicycle pedals based on measurements made with a plurality of force-measuring sensors. The ability to determine and record the forces applied by the bicyclist during a ride enables a more detailed analysis of the bicyclist's performance. “Performance” may be defined as any objective metric such as speed, power output, total energy used, heart pulse rate, or other directly or indirectly determinable parameters, and also subjective metrics such as perceived exertion, fatigue level, or fit comfort.

The bicyclist has an interest in improving their power output, endurance, or riding comfort in real-time. Spin-scan plots and quadrant analysis (QA) plots are known metrics used by conventional devices that allow for inferring neuromuscular activity and bicycle power, but these are limited in a real-time environment. While spin-scan plots provide a great deal of information, it may be more detail than the bicyclist can consider while actively engaged in riding. A QA plot provides useful information about the force-cadence characteristic of a given bicyclist or ride, but it does not lend itself well to showing changes in applied pedaling forces throughout the ride. Accordingly, what is needed is a metric that provides a concise description of a bicyclist's pedal stroke characteristic, may be intuitively displayed in real-time, and may also be graphed in a time sequence for post-ride analysis.

In some embodiments, the technology measures and displays “power phase angles” (or, simply, “power phase”). During steady-state bicycling, a typical bicyclist's pedal force, relative to the crank angle, is as described below. Some basic characteristics that may be distilled from this are the “torque effectiveness” and “pedal smoothness”, as is done by conventional devices. However, if the pedaling system is capable of measuring the crank angle throughout the pedal cycle then the crank angle at which the torque becomes positive and the crank angle at which the torque becomes negative may also be determined. Additionally, the peak power zone, in which the bicyclist realizes the most significant fraction of driving torque for a given pedal stroke, may be calculated. Separates measures may be obtained for each pedal using one or more sensors that independently measures each leg's contribution, though the peak power zones may still be approximately obtained with a power measurement that combines both legs' contributions.

The power phase metrics may be the “start angle” at which torque first becomes positive, the “end angle” at which the torque first becomes negative, the “peak start angle” identifying the onset of the peak output fraction, and the “peak end angle” identifying the termination of the peak output fraction. Other measures, such as the peak torque angle and the peak width, may be determined analytically from the power phase metrics directly or from the data underlying the power phase metrics.

Garmin' s Vector™ pedals may be used to provide the measurements needed to calculate the above-described metrics. More specifically, the plurality of sensors described in U.S. Pat. No. 8,011,242 may be used to measure the radial, tangential, and other forces on the bicycle's pedals. The Vector™ pedals themselves may be configured to also perform the analysis on this data and/or other devices, such as Garmin's Edge® or Forerunner® global positioning system (GPS) devices, paired with the Vector™ pedals may perform the analysis.

In some cases, the geographic location associated with certain metric values or changes in those values may be of interest. As such, it may be desirable to combine records of the metric values and changes those values with geolocation data such as might be obtained from GPS devices such as Garmin' s Edge® or Forerunner® GPS devices. Similarly, in some cases, other bicycle performance metrics, such as speed or attitude, and bicyclist performance metrics, such as heart rate, associated with the power phase and force-related data may be of interest. As such, it may be desirable to combine records of the metric values and changes in those values with records of these other performance metrics and changes in them.

When combined with the Garmin's Edge® or Forerunner® GPS devices, the bicyclist may record their power phase and other force-related data along with the correlated geographic location data and the correlated one or more performance metrics. The power phase and other force-related data may be provided to the bicyclist in real-time (via the Edge® or Forerunner® GPS devices or other devices such as smart phones) to allow the bicyclist to adjust their performance if necessary. Thus, embodiments of the invention enable the Vector™ pedals (and/or a paired device such as the Edge® or Forerunner® GPS devices) to determine power phase and other force-related data in real-time, display the power phase and other force-related data in real-time using a graphic presentation that is readily understandable by the bicyclist while riding, and correlate the power phase and other force-related data with GPS location data and/or performance metrics data.

In one embodiment, the analysis may use knowledge of the bicyclist's weight. The bicyclist's weight may be entered into the system by having the bicyclist stand on the Vector™ pedals, wherein the pedals are configured to determine the bicyclist's weight, or by entering the weight into the head unit (e.g., the Edge® or Forerunner® devices).

One aspect of bicycle “fit” that may be important to the long-term comfort of a bicyclist is the lateral alignment of the bicyclist's knees through the pedal stroke. A number of factors such as the rotation and horizontal location of the pedal cleat, as well as the installation of angle wedges between the cleat and the shoe, may influence this alignment. Some of these adjustments manifest themselves as influences on the lateral location of force application on the pedal. Thus, if the lateral location of force application may be determined and recorded, then this information may be used to improve a fitter's ability to determine an optimal pedal/cleat alignment for a rider. Vector™ pedals determine the lateral location of force application through the pedal stroke and report this value on a per-cycle basis as Platform Center Offset (PCO). In addition to a per-cycle averaging, Vector™ pedals may determine PCO variation throughout the pedal stroke, which may be of additional benefit to a bicyclist.

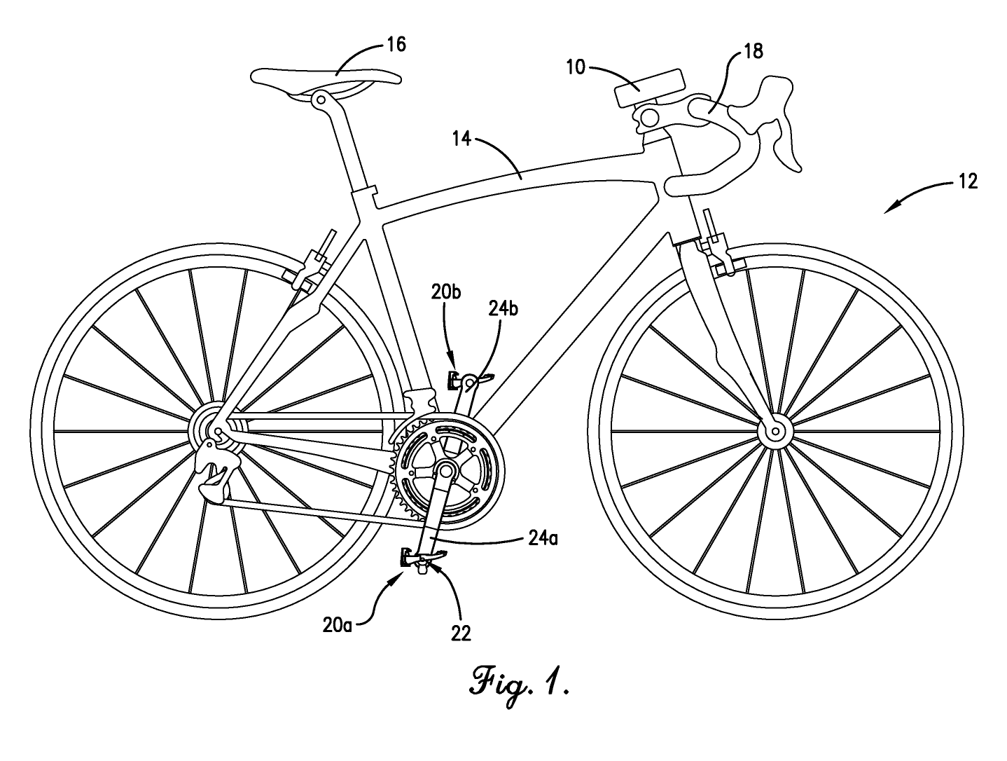

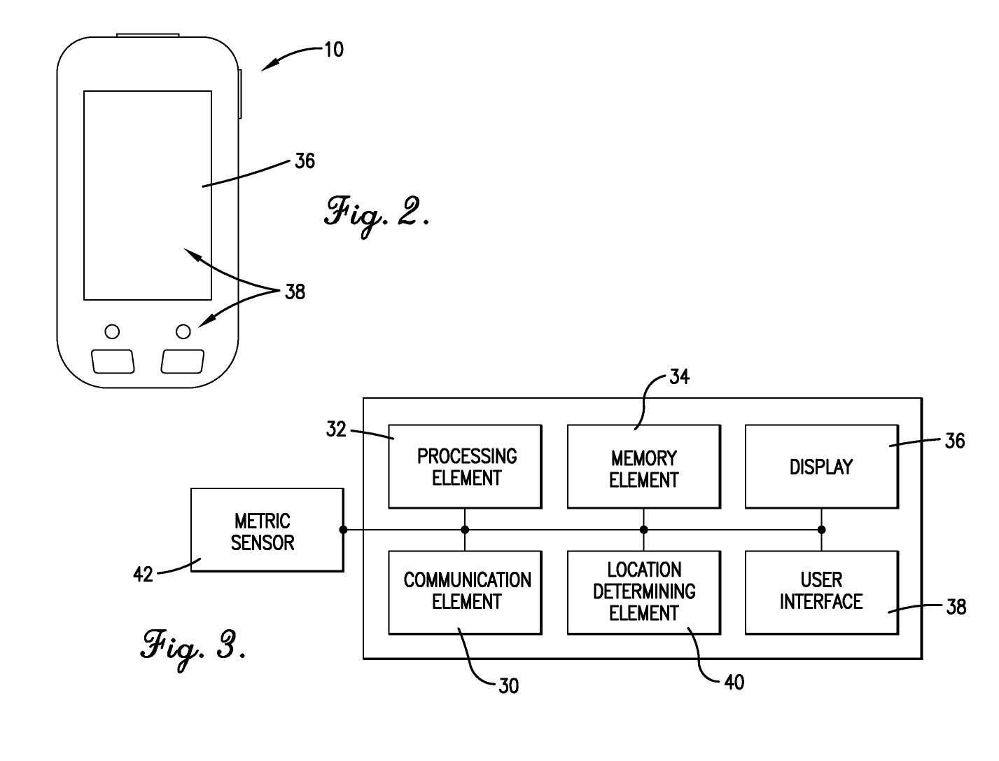

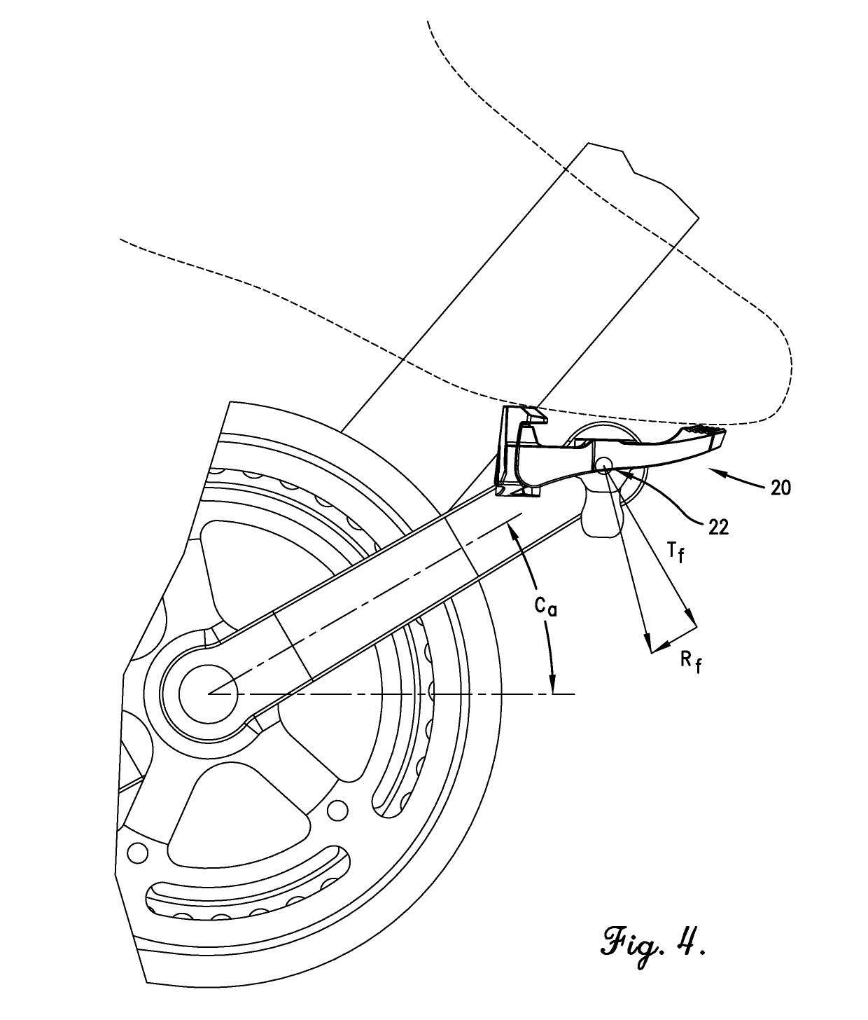

Embodiments of the technology will now be described in more detail with reference to the drawing figures. Referring initially to FIGS. 1 and 2, an electronic device 10 configured to determine forces applied by a bicyclist while the bicyclist is riding a bicycle 12. The bicycle 12 is shown broadly comprising a frame 14, a seat 16, a handlebar 18, and left and right pedals 20a,20b, one or more sensors 22 associated with the left and right pedals 20a,20b, and left and right cranks 24a,24b to which the left and right pedals 20a,20b are respectively attached. The electronic device 10 may be removably mountable on the bicycle 12, and is shown mounted on the handle bar 18 in FIG. 1 and unmounted in FIG. 2. The bicycle 12, including the frame 14, seat 16, handlebar 18, and left and right pedals 20a,20b may be of substantially any suitable type and design, and any details of these components of the system described herein or shown in the figures are for illustrative purposes only and are not limiting of the technology. For example, the bicycle 12 may be of any suitable type and design, such as a conventional road bicycle or a triathlon bicycle.

The one or more sensors 22 may be configured to measure the forces exerted by the bicyclist on the left and right pedals 20a,20b. The sensors 22 may be of any suitable type and design configured to measure the force. In one embodiment, the sensors 22 may be substantially as described in U.S. Pat. No. 8,011,242 and configured to measure radial, tangential, and other forces on the left and right pedals 20a,20b to determine power phase and other force-related information. The sensors 22 may be located, for example, on the left and right pedals 20a,20b themselves or on spindles coupled with the pedals 20a,20b and cranks 24a,24b. Such sensors are incorporated into Garmin's Vector™ pedals, and therefore these particular pedals could function as the left and right pedals 20a,20b and the sensors 22. In one implementation, electronics associated with the pedals 20a,20b and/or the sensors 22 may be configured to perform the power phase-determining analysis on the force measurement data generated by the sensors 22. Additionally or alternatively, the electronic device 10, may be configured to receive the force measurement data from the sensors 22 and perform this analysis to determine the power phase and other force-related information.

Referring also to FIG. 3, in an embodiment in which the electronic device 10 both performs the analysis and communicates the results, the electronic device 10 may include a communication element 30, a processing element 32, a memory element 34, and a display 36. The communication element 30 may be in wireless or wired communication with the sensors 22 and configured to receive the force measurement data generated by the sensors 22 regarding the forces applied by the bicyclist to the left and right pedals 20a,20b. The communication element 30 may be implemented using any appropriate technology and design, and may include signal or data transmitting and receiving circuits, such as amplifiers, filters, mixers, oscillators, digital signal processors (DSPs), and the like. Furthermore, the communication element 30 may establish communication wirelessly by utilizing radio frequency (RF) signals and/or data that comply with communication standards such as cellular 2G, 3G, or 4G, Institute of Electrical and Electronics Engineers (IEEE) 802.11 standard such as WiFi, IEEE 802.16 standard such as WiMAX, Bluetooth™, or combinations thereof. In addition, the communication element 30 may utilize communication standards such as ANT, ANT+, Bluetooth™ low energy (BLE), the industrial, scientific, and medical (ISM) band at 2.4 gigahertz (GHz), or the like. Additionally or alternatively, the communication element 30 may establish communication through connectors or couplers that receive metal conductor wires or cables or optical fiber cables.

The processing element 32 may be configured to analyze the received force measurement data to determine the power phase and other force-related information. In one embodiment, the processing element 32 may analyze the received force measurement data to create a concise description of the bicyclist's pedal stroke characteristic, including the amount of force applied to each pedal 20, which is suitable for display and consideration in real-time while riding as well as for post-ride analysis. The processing element 32 may be implemented using any appropriate technology and design, and may include processors, microprocessors, microcontrollers, digital signal processors (DSPs), field-programmable gate arrays (FPGAs), analog and/or digital application-specific integrated circuits (ASICs), or the like, or combinations thereof. The processing element 32 may generally execute, process, or run instructions, code, code segments, software, firmware, programs, applications, apps, processes, services, daemons, or the like, or may step through the states of a finite-state machine.

The analysis of the force measurement data to determine power phase may involve determining power phase angles as a function of force exerted on each pedal 20 relative to the angle Cₐ of the crank 24a,24b to which the pedal 24 is attached. In one embodiment, the analysis may involve determining certain power phase metrics including the “start angle” at which torque first becomes positive, the “end angle” at which the torque first becomes negative, the “peak start angle” identifying the onset of the peak output fraction, and the “peak end angle” identifying the termination of the peak output fraction. Other measures, such as the peak torque angle and the peak width, may be determined analytically from these power phase metrics directly or from the data underlying the power phase metrics.

The memory element 34 may be configured to record the results of the processing element's analysis over time as a series of changes in the power phase and other force-related information while the bicyclist is riding the bicycle 12. The memory element 34 may be implemented using any appropriate technology and design, and may include data storage components such as read-only memory (ROM), programmable ROM, erasable programmable ROM, random-access memory (RAM), hard disks, floppy disks, optical disks, flash memory, thumb drives, universal serial bus (USB) drives, or the like, or combinations thereof. The memory element 34 may include, or may constitute, a “computer-readable medium”. The memory element 34 may store instructions, code, code segments, software, firmware, programs, applications, apps, services, daemons, or the like that are executed by the processing element 32. The memory element 34 may also store settings, data, documents, sound files, photographs, movies, images, databases, and the like.

The display 36 may be configured to present the results of the processing element's analysis of the data in real-time or, for data stored in the memory element 34, at a later time. The display 36 may be implemented using any appropriate technology and design, such as light-emitting diode (LED), organic LED (OLED), Light Emitting Polymer (LEP) or Polymer LED (PLED), liquid crystal display (LCD), thin film transistor (TFT) LCD, LED side-lit or back-lit LCD, or the like, or combinations thereof. Furthermore, the display 36 may have a round, circular, or oval shape; may possess a square or a rectangular aspect ratio which may be viewed in either a landscape or a portrait mode; and may further include a lens or other covering overlying all or part of the display 36 and configured to enhance the visibility of the information shown on the display 36.

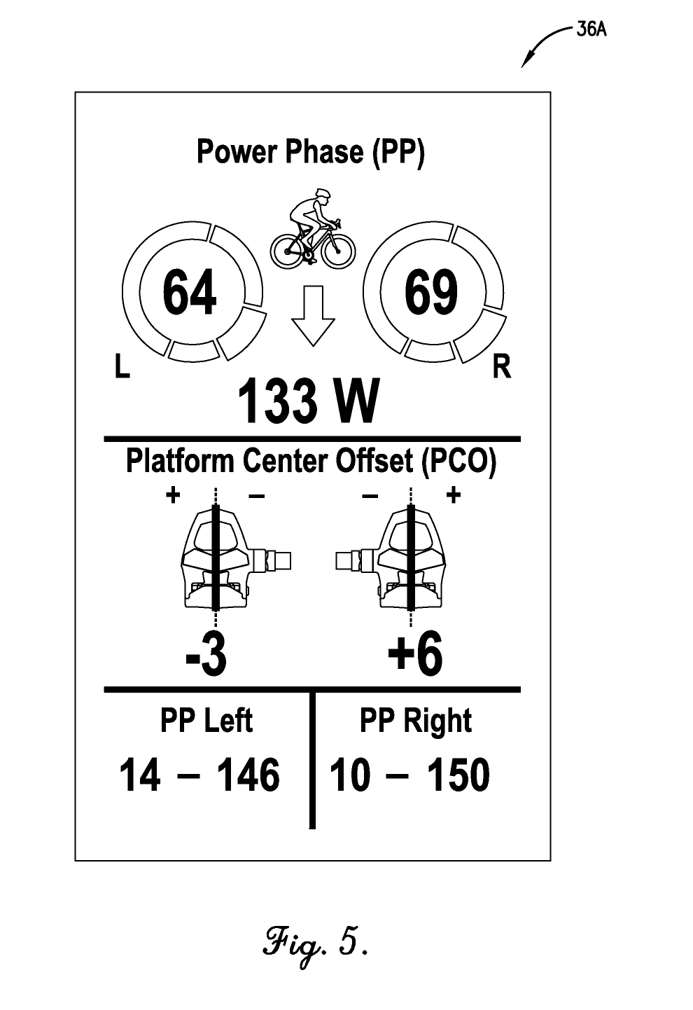

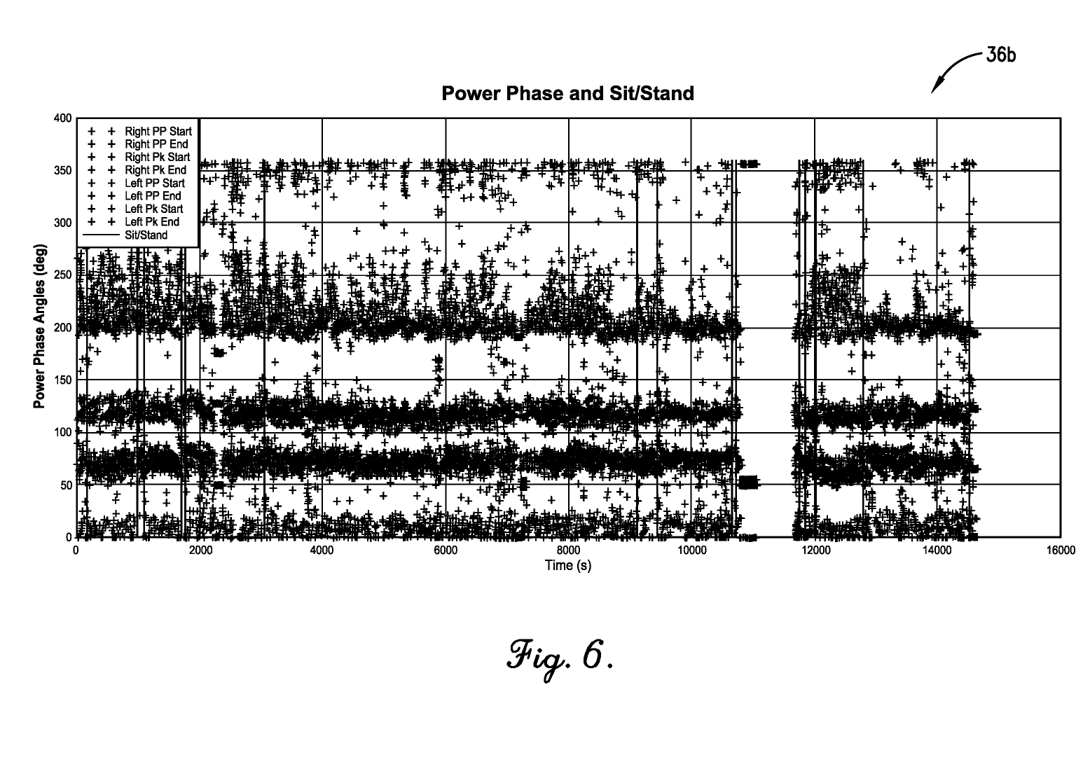

Referring also to FIG. 5, an exemplary real-time presentation 36A of the power-phase and other force-related information (e.g., platform center offset), is depicted as it might be shown on the display 36. In particular, the presentation 36A may graphically communicate a concise description of the bicyclist's per-cycle pedal stroke characteristic in such a manner as to facilitate real-time understanding and consideration by the bicyclist while riding. Referring also to FIG. 6, an exemplary post-ride graphical presentation 36B of the series of changes in the power phase and other force-related information (e.g., bodily position, whether sitting or standing), is depicted as it might be shown on the display 36 or tablet, laptop, desktop, or other computing device for post-ride analysis.

In one implementation, the electronic device 10 may further include a user interface 38 configured to allow the bicyclist or other user of the electronic device 10 to provide input regarding, for example, how the analysis is performed or how the results are displayed. The user interface 38 may be implemented using any appropriate technology and design, such as pushbuttons, rotating knobs, or the like, or combinations thereof. Furthermore, the user interface 38 may take the form of a touchscreen occupying part or all of the display 36 and allowing the user to interact with the electronic device 10 by physically touching, swiping, or gesturing on or near areas of the display 36. Additionally or alternatively, the user interface 38 may employ voice control technology or facial recognition technology.

In one embodiment, the electronic device 10 may further include or otherwise be in communication with via the communication element 30 a location-determining element 40 configured to determine a geographic location of the bicyclist while riding the bicycle 12. In this embodiment, the memory element 34 may be further configured to record a series of changes in the geographic location, the processing element 32 may be further configured to correlate the series of changes in the power phase and other force-related information with the series of changes in the geographic location, and the display 36 may be further configured to graphically communicate the correlated series of changes in the power phase or other force-related information and the series of changes in the geographic location. Exemplary electronic devices having such location-determining capability include Garmin' s Edge® and Forerunner® GPS devices, and therefore either of these particular devices could be configured to function as the electronic device 10.

More broadly, the location-determining element 40 may be implemented using any appropriate technology and design, such as receiving and processing radio frequency (RF) signals from a global navigation satellite system (GNSS) such as the global positioning system (GPS) primarily used in the United States, the GLONASS system primarily used in the Soviet Union, the BeiDou system primarily used in China, or the Galileo system primarily used in Europe. The location-determining element 40 may accompany or include an antenna to assist in receiving the satellite signals. The antenna may be a patch antenna, a linear antenna, or any other type of antenna that may be used with location or navigation devices. The location-determining element 40 may include satellite navigation receivers, processors, controllers, other computing devices, or combinations thereof, and memory. The location-determining element 40 may process a signal, referred to herein as a “location signal”, from one or more satellites that includes data from which geographic information such as the current geolocation is derived. The current geolocation may include coordinates, such as the latitude and longitude, of the current location of the electronic device 10.

It will be appreciated that substantially any other location-determining technology may be used. For example, cellular towers or any customized transmitting radio frequency towers may be used instead of satellites may be used to determine the location of the electronic device 10 by receiving data from at least three transmitting locations and then performing basic triangulation calculations to determine the relative position of the device with respect to the transmitting locations. With such a configuration, any standard geometric triangulation algorithm may be used to determine the location of the electronic device 10. The location-determining element 40 may also include or be coupled with a pedometer, accelerometer, compass, or other dead-reckoning components which allow it to determine the location of the electronic device 10. The location-determining element 40 may determine the current geographic location through a communications network, such as by using Assisted GPS (A-GPS), or from another electronic device. The location-determining element 40 may even receive location data directly from the user.

In another embodiment, the electronic device 10 may further include or otherwise be in communication with via the communication element 30 one or more additional performance metric sensors 42 configured to measure one or more aspects of the bicycle's or the bicyclist's performance. These aspects may be objective or subjective, and may include any one or more of a speed of the bicycle 12, an attitude of the bicycle 12, a total energy used by the bicyclist, a heart rate of the bicyclist, an exertion perceived by the bicyclist, a fatigue level of the bicyclist, a cadence of the bicyclist, and a fit comfort of the bicyclist. In this embodiment, the memory element 34 may be further configured to record a series of changes in one or more performance metrics, the processing element 32 may be further configured to correlate the series of changes in the power phase and other force-related information with the series of changes in the one or more performance metrics, and the display 36 may be further configured to graphically communicate the correlated series of changes in the power phase and other force-related information and the series of changes in the one or more performance metrics.

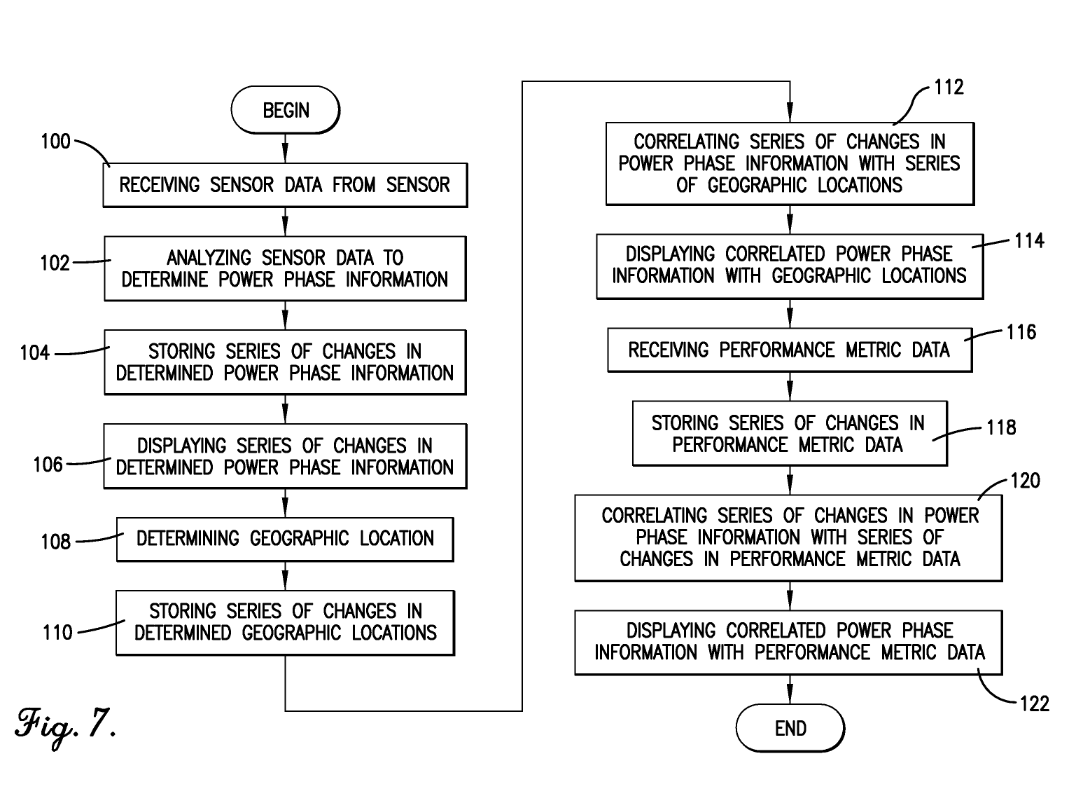

Referring also to FIG. 7, in operation the electronic device 10 may function substantially as follows to determine the power phase and other force-related information while the bicyclist is riding the bicycle 12. Broadly, the communication element 30 of the electronic device 10 may receive sensor data from the one or more force-measuring sensors 22 regarding the forces applied by the bicyclist to the left and right pedals 20a,20b, as shown in step 100. The sensor data may be provided to the processing element 32 which analyzes it to create a concise description of the bicyclist's pedal stroke characteristic, as shown in step 102. The result of the processing element's 32 analysis may be provided to the memory element 34 to be stored as a series of changes in the bicyclist's pedal stroke characteristic or other force-related information while the bicyclist is riding the bicycle 12, as shown in step 104. The current pedal stroke characteristic information and/or the series of changes in the pedal stroke characteristic or other force-related information may be provided to the display 36 to be graphically displayed for the user in real-time during the ride or for post-ride analysis, as shown in step 106.

In one embodiment, the location-determining element 40 of the electronic device 10 may determine the geographic location of the bicyclist, as shown in step 108. The geographic location data may be provided to the memory element 34 to be stored as a series of changes in the geographic location of the bicyclist while the bicyclist is riding the bicycle 12, as shown in step 110. The processing element 32 may then correlate the series of changes in the bicyclist's power phase or other force-related information with the series of changes in the geographic location, as shown in step 112. The correlated series of changes in the bicyclist's power phase or other force-related information and the series of changes in the geographic location may be provided to the display 36 to be graphically displayed for the user, as shown in step 114.

In another embodiment, the communication element 30 of the electronic device 10 may receive performance metric data from the one or more additional performance metric sensors 42 regarding the performance metrics being measured, as shown in step 116. The performance metric data may be provided to the memory element 34 to be stored as a series of changes in the performance metrics being measured while the bicyclist is riding the bicycle 12, as shown in step 118. The processing element 32 may then correlate the series of changes in the power phase or other force-related information with the series of changes in the one or more performance metrics, as shown in step 120. The correlated series of changes in the power phase or other force-related information and the series of changes in the one or more performance metrics may be provided to the display 36 to be graphically displayed for the user, as shown in step 122.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. An electronic device configured to determine a power phase performance by a bicyclist while the bicyclist is riding a bicycle, wherein the bicycle includes a seat, a handlebar, left and right pedals, and one or more sensors configured to measure a force applied by the bicyclist to each of the left and right pedals, the electronic device comprising:
a communication element configured to receive data from the one or more sensors regarding the force applied by the bicyclist to the left and right pedals;
a processing element configured to analyze the data to determine the power phase performance by the bicyclist; and
a memory element configured to record a series of changes in the power phase performance while the bicyclist is riding the bicycle.

2. The electronic device as set forth in claim 1, wherein the one or more sensors are configured to measure a radial force and a tangential force applied by the bicyclist to the left and right pedals.

3. The electronic device as set forth in claim 1, wherein the one or more sensors are configured to measure a total vertical force applied by the bicyclist to the left and right pedals.

4. The electronic device as set forth in claim 1, wherein the bicycle further includes a left crank to which the left pedal is attached and a right crank to which the right pedal is attached, and wherein the processing element is configured to determine the power phase performance based on the force applied by the bicyclist to the left and right pedals and corresponding angles of the left and right cranks.

5. The electronic device as set forth in claim 4, wherein the processing element is configured to determine the power phase performance based on the force applied by the bicyclist when the left and right cranks are at—
a start angle at which a torque becomes positive;
an end angle at which the torque becomes negative;
a peak start angle corresponding to an onset of a peak output fraction; and
a peak end angle corresponding to a termination of the peak output fraction.

6. The electronic device as set forth in claim 5, wherein the processing element is further configured to determine a peak torque angle and a peak width.

7. The electronic device as set forth in claim 5, wherein the processing element is further configured to determine a platform center offset based on a lateral location of the force applied by the bicyclist.

8. The electronic device as set forth in claim 1, further comprising—
a location-determining element configured to determine a geographic location of the bicyclist while the bicyclist is riding the bicycle,
wherein the memory element is further configured to record a series of changes in the geographic location,
wherein the processing element is further configured to correlate the series of changes in the power phase performance with the series of changes in the geographic location; and
a display configured to graphically communicate the correlated series of changes in the power phase performance and the series of changes in the geographic location.

9. The electronic device as set forth in claim 1, wherein—
the bicycle further includes one or more additional performance metric sensors configured to measure one or more performance metrics of the bicyclist or the bicycle while the bicyclist is riding the bicycle,
wherein the memory element is further configured to record a series of changes in the one or more performance metrics,
wherein the processing element is further configured to correlate the series of changes in the power phase performance with the series of changes in the one or more performance metrics; and
the electronic device further includes a display configured to graphically communicate the correlated series of changes in the power phase performance and the series of changes in the one or more performance metrics.

10. The electronic device as set forth in claim 1, further including a display that is mountable to the handlebar and configured to graphically communicate the power phase performance in real-time.

11. An electronic device configured to determine a power phase performance by a bicyclist while the bicyclist is riding a bicycle, wherein the bicycle includes a seat, a handlebar, left and right pedals, a left crank to which the left pedal is attached, a right crank to which the right pedal is attached, and one or more sensors configured to measure a force applied by the bicyclist to each of the left and right pedals, the electronic device comprising—
a communication element configured to receive data from the one or more sensors regarding the radial and tangential forces applied by the bicyclist to the left and right pedals;
a processing element configured to analyze the data to determine the power phase performance by the bicyclist based on the force applied by the bicyclist to the left and right pedals and corresponding angles of the left and right cranks.
a memory element configured to record a series of changes in the power phase performance while the bicyclist is riding the bicycle,
the memory element being further configured to record a series of changes in a geographic location of the bicyclist and to record a series of changes in one or more performance metrics while the bicyclist is riding the bicycle, and
the processing element being further configured to correlate the series of changes in the power phase performance with the series of changes in the geographic location and with the series of changes in the one or more performance metrics; and
a display configured to graphically communicate the power phase performance in real-time, and to communicate the correlated series of changes in the power phase performance, the series of changes in the geographic location, and the series of changes in the one or more performance metrics.

12. A method of determining a power phase performance of a bicyclist while the bicyclist is riding a bicycle, wherein the bicycle includes a seat, a handlebar, left and right pedals, and one or more sensors configured to measure a force applied by the bicyclist to the left and right pedals, the method comprising the steps of:
receiving data via a communication element from the one or more sensors regarding the force applied by the bicyclist to the left and right pedals;
analyzing the data using a processing element to determine the power phase performance by the bicyclist;
recording in a memory element a series of changes in the power phase performance while the bicyclist is riding the bicycle; and
graphically communicating using an electronic display the series of changes in the power phase performance in real-time.

13. The method as set forth in claim 12, wherein the one or more sensors are configured to measure a radial force and a tangential force applied by the bicyclist to the left and right pedals.

14. The method as set forth in claim 12, wherein the one or more sensors are configured to measure a total vertical force applied by the bicyclist to the left and right pedals.

15. The method as set forth in claim 12, wherein the bicycle further includes a left crank to which the left pedal is attached and a right crank to which the right pedal is attached, and wherein the step of analyzing the data to determine the power phase performance involves correlating the force applied by the bicyclist to the left and right pedals with corresponding angles of the left and right cranks.

16. The method as set forth in claim 15, wherein the step of analyzing the data includes determining, with regard to the left and right cranks,—
a start angle at which a torque becomes positive;
an end angle at which the torque becomes negative;
a peak start angle corresponding to an onset of a peak output fraction; and
a peak end angle corresponding to a termination of the peak output fraction.

17. The method as set forth in claim 16, wherein the step of analyzing the data further includes determining, with regard to the left and right cranks, a peak torque angle and a peak width.

18. The method as set forth in claim 16, wherein the step of analyzing the data further includes determining a platform center offset based on a lateral location of the force applied by the bicyclist.

19. The method as set forth in claim 12, further including the steps of—
determining a geographic location of the bicyclist while the bicyclist is riding the bicycle;
recording in the memory element a series of changes in the geographic location;
correlating the series of changes in the power phase performance with the series of changes in the geographic location using the processing element; and
graphically communicating on a display the correlated series of changes in the power phase performance and the series of changes in the geographic location.

20. The method as set forth in claim 12, further including the steps of—
receiving data via the communication element from and additional performance metric sensor regarding a performance metric of the bicycle or the bicyclist;
recording in the memory element a series of changes in the performance metric;
correlating the series of changes in the power phase performance with the series of changes in the performance metric using the processing element; and
graphically communicating on an electronic display the correlated series of changes in the power phase performance and the series of changes in the performance metric.
